(19) United States
(12) Patent Application Publication
(10) Pub. No.: US 2003/0045341 A1
(43) Pub. Date: Mar. 6, 2003

(54) Voice activated electronic bingo device

(76) Inventors: Yuri Itkis, Las Vegas, NV (US); Boris Itkis, Las Vegas, NV (US)

Correspondence Address: Quirk & Tratos, Suite 500 North, 3773 Howard Hughes Parkway, Las Vegas, NV, 89109, US

(21) Appl. No.: 09/947,327

(22) Filed: Sep. 5, 2001

(51) Int. Cl. G06F 17/00

(52) U.S. Cl. 463/19

(57) ABSTRACT

A voice-activated electronic bingo player unit facilitates automatic playing of bingo. Via a microphone, the unit receives bingo caller's game announcements broadcast over a conventional public announcement system. The unit digitally processes the received sound signals, recognizes received voice commands matching standard samples stored in its memory and utilizes the recognized voice commands in lieu of player's manual entries and/or in lieu of conventional game commands received over a gaming network. Via a point of sale terminal, the unit is downloaded with a library of voice samples of a bingo caller who conducts the current bingo session. In order to facilitate the recognition of voice commands, the actual bingo caller's voice announcements are filtered-out from the background noise and compressed by the bingo caller terminal before broadcasting via the public announcement system. The voice-activated bingo caller terminal also drives bingo flashboards.

### BACKGROUND OF THE INVENTION

This invention relates to gaming and amusement devices, and more specifically, to electronic bingo devices.

Within the last decade various electronic devices and systems have been successfully adapted for use in bingo halls. In particular, electronic bingo player units, such as disclosed in U.S. Pat. Nos. 4,378,940 to Gluz et al., 4,455,025 to Itkis, 4,624,462 to Itkis and U.S. Pat. No. 4,856,787 to Itkis gained a broad popularity amongst bingo players as described, in the industry publications “Bingo on the Rebound”, International Gaming & Wagering Business, March 2000; “The Electronic Invasion”, Bingo Manager, August 1995; “Paper Security”, Bingo Manager, October 1995; “Competing on Calling Equipment”, Bingo Manager, June 1996; “Technology In the Palm of Your Hand”, Bingo Manager, November 1997; “The Electronic Management of Information”, Bingo Manager, September 1997; “Calling on Caller Equipment”, Bingo Manager, February 1998; “Color and Animation Improve Hand-Held Bingo”, Bingo Manager, October 1999; “Management Information Systems Insure Hall Integrity”, Bingo Manager, June 2000; “Electronics Evolve with New Ideas”, Bingo Manager, July 2000; “High Stakes Games Create Excitement and Profits”, Bingo Manager, August 2000.

An overwhelming majority of commercial electronic bingo player units operate in a manual mode, including a player manually entering at least some of the data necessary for operation of the device, such as called bingo numbers as taught in Gluz. More advanced commercial models of bingo player units may operate automatically, with the capability to receive at least a part of the necessary data from a master bingo caller terminal over a communication channel. Both the manual and the automatic modes of operation have their respective drawbacks. Specifically, the manual mode is error-prone and burdensome for the player, whereas the automatic mode requires an elaborate and expensive wired and/or wireless communication network.

A known alternative to both manual data entry and remote data entry into electronic devices is various speech recognition techniques as disclosed in U.S. Pat. Nos. 5,208,449 to Eastman et al., 4,757,525 to Matthews et al., 5,158,212 to Sirhan, 6,039,626 to Gerold et al., and U.S. Pat. No. 5,562,453 to Wen. Although U.S. Pat. No. 4,856,787 to Itkis teaches voice activated gaming devices, heretofore, such devices have not found application in casinos and bingo halls due to severe security and background noise limitations. With the game of bingo specifically, conventional voice-activation techniques are not applicable directly. First, all conventional voice-activated devices are user-operated, whereas players in a bingo hall are expressly forbidden to talk during the bingo game and, therefore, are not allowed to speak into their bingo player units. Moreover, known techniques of voice recognition, such as disclosed in U.S. Pat. No. 5,893,064 to Kudirka et al., requires either specific tuning or preprogramming of the device for a specific user's voice or necessitate and/or a prolonged and elaborate “training” of the device by its designated user. However, commercial electronic bingo player units are typically owned by bingo halls, and therefore, the users of the bingo player unit change from a bingo session to a bingo session. Consequently, it is not practical to expect a player to “teach”, especially in case of a first time user of an electronic bingo player unit, a rented bingo unit to understand his/her voice commands in such a short time.

On the other hand, virtually each bingo hall is equipped with a caller-operated public address system that includes a microphone, an audio amplifier and one or more loudspeakers. However, a public address system is a stand-alone system and is totally disassociated from all other equipment in the bingo hall and, therefore, is not utilized to its full potential. Moreover, a bingo caller may mistakenly announce via a public address system one bingo number and enter a totally different bingo number in the bingo console resulting in a wrong number indication on the bingo flashboard and/or wrong number shown on the displays of electronic bingo player units. Similarly, a player may erroneously enter a wrong number into a player unit and/or “daub” a wrong number on paper bingo cards. In addition, bingo callers frequently change and bingo players have to adapt to unique voice characteristics of the current bingo caller. The situation is further aggravated by the ever-present strong background noise generated primarily by bingo ball hopper.

### SUMMARY OF THE INVENTION

The present invention has a general objective of facilitating operation of gaming devices by eliminating the need in cumbersome manual entry of gaming commands and data.

More specifically, the invention pursues an objective of assuring a total match between the announcement made by a bingo caller and information displayed on electronic bingo devices, such as bingo flashboards and bingo player units.

A further objective of the present invention is to achieve such a match without a need for the user to manually enter appropriate commands and without expensive wired and/or wireless communication networks.

A further objective of the present invention is to minimize the required computational, memory and power resources of electronic bingo devices capable of satisfying the above objectives of the invention.

These and other objectives of the invention will become more apparent from the attached drawings and the following description of the preferred embodiment.

A speech recognition means embedded in a player unit and/or bingo caller terminal is a key element of the present invention that enables a fulfillment of the above objectives. The embedded voice command recognition hardware and software discern a limited set of bingo caller's announcements, such as called bingo numbers, bingo patterns and game-start and game-end commands. Specifically, an electronic bingo player unit is improved by substituting a speech recognition circuitry, including a microphone, an analog-to-digital converter (“A/D convertor”) and a digital signal processor (“DSP”) preprogrammed to recognize a limited set of caller's voice commands, for a radio frequency (“RF”) receiver. The microphone receives a caller's announcements broadcast through the laud-speakers of the public address system and the A/D converter digitizes said microphone's output signal. The DSP processes the digitized voice signal and detects legible voice commands by comparing the incoming signal with a library of prerecorded voice command samples. The recognized voice commands (e.g., “GAME OVER”) are input into an existing microprocessor of a bingo player unit in lieu of equivalent commands entered by a player and/or received from a bingo caller terminal over a conventional RF communication network.

In view of the limited computational and power resources of the hand-held bingo player unit, the library of voice commands recognizable by the unit is optimized and minimized to include only the absolutely necessary voice commands. The library is also optimized for a specific caller's voice. In order to accommodate several bingo callers conducting bingo games in the same bingo hall, the library of voice commands is tuned to the voice of a particular caller who conducts the current bingo session. The optimized library is downloaded from a point of sale terminal into the bingo player unit before the start of the current bingo session. In addition, a caller's voice signal generated by a caller's microphone is filtered-out by the bingo caller terminal to reject noise caused primarily by bingo ball hopper and is digitally compressed to reduce overall voice signal bandwidth before broadcasting the voice announcements over the PA system. The voice commands detected by a bingo caller terminal are also utilized to drive a bingo flashboard in lieu of the manual entry of called bingo numbers, resulting in essentially a “hands-free” voice-activated flashboard.

### DESCRIPTION OF THE DRAWINGS

FIG. 1 illustrates a block diagram of voice-activated electronic bingo playing system.

FIG. 2 illustrates a block diagram of bingo caller terminal driving a public announcement system.

FIG. 3 illustrates a block diagram of a bingo caller terminal equipped with noise-rejection circuitry.

FIG. 4 illustrates a block diagram of a point of sale terminal downloading electronic bingo player unit with a voice-command library.

### DESCRIPTION OF THE PREFERRED EMBODIMENT

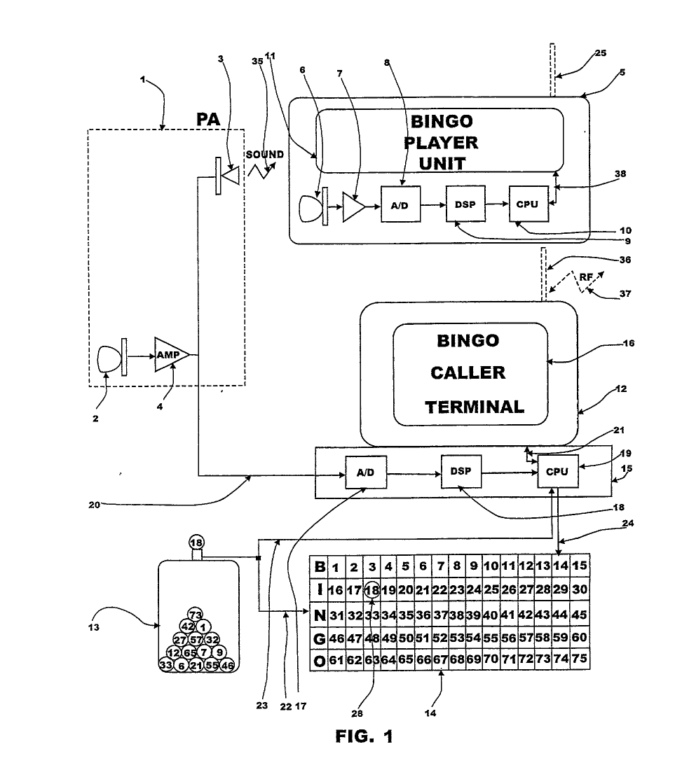

A block-diagram of the invention is illustrated in FIG. 1, wherein the present invention includes a public address system 1 further including a bingo callers microphone 2 interconnected to loudspeaker 3 through a power amplifier 4. Although only one loudspeaker 3 is shown in FIG. 1, more than one parallel loudspeaker 3 is typically utilized in a bingo hall. Additionally, shown in FIG. 1, is a portable hand-held bingo player unit 5 incorporating serially interconnected microphone 6, preamplifier 7, A/D converter 8, DSP 9 and central processing unit (“CPU”) 10. Although only one bingo player unit 5 is shown in FIG. 1, more than one bingo player unit 5 is typically utilized in a bingo hall. Via cable 38, CPU 10 is further interfaced with a color LCD touchscreen 11 embedded into bingo player unit 5.

FIG. 1 also shows a PC-compatible bingo caller terminal 12, such as disclosed in U.S. Pat. No. 4,373,726 to Churchill et al., a bingo ball hopper 13 and a bingo flashboard 14 such as disclosed in U.S. Pat. No. 4,332,389 to Lloyd. Bingo caller terminal 12 includes a PC-compatible computer 15 and a color CRT touchscreen monitor 16 interfaced with computer 15 via cable 21. PC-compatible computer 15 incorporates a serial chain of elements consisting of an A/D converter 17, a DSP 18 and a CPU 19. The input of A/D 17 is interconnected with the output of the power amplifier 4 via a cable 20 and the output of CPU 19 is interconnected with touchscreen 16 via cable 21. In a majority of bingo halls, ball hopper 13 is interfaced with flashboard 14 via a cable 22. Although only one Dashboard 14 is shown in FIG. 1, several daisy-chained flashboards are typically employed in a bingo hall. In more modern bingo halls, bingo hopper 13 is interfaced with bingo flashboard 14 not directly but via bingo caller terminal 12. Specifically, bingo ball hopper 13 is interconnected with CPU 19 of bingo caller terminal 12 via a cable 23, and CPU 19 in turn, is interconnected with flashboard 14 via a cable 24.

Loudspeaker 3 and microphone 6 are acoustically-coupled such that microphone 6 of player unit 5 is capable of receiving sounds emitted by loudspeaker 3 of the public address system 1. While conducting a bingo game, a bingo caller makes various game-relevant announcements by speaking into microphone 1. For example, a bingo caller pronounces “I EIGHTEEN” to announce that the new called bingo number is eighteen and that it belongs to the “I” row of seventy-five bingo numbers on bingo Dashboard 14. Typically, the last ball is blinking on the flashboard 14 as illustrated by a circle 28 surrounding the number eighteen on the Dashboard 14. Similarly, a bingo caller says “GAME OVER” into microphone 2 to announce that the current bingo game is finished. Microphone 6 converts the air pressure of a caller's voice into a low-current, low-voltage electric signal that is amplified by audio amplifier 4 to a level adequate for driving loudspeaker 3. The amplified voice of the bingo caller is carried by loudspeaker 3 or a plurality of parallel loudspeakers throughout a bingo hall and is received by built-in microphone 6 of player unit 5. Microphone 6 converts the incoming sound signal into a low-voltage and low-current electrical signal that is amplified and filtered by preamplifier 7. The analog signal generated by preamplifier 7 is digitized by A/D converter 8. The digital output signal of A/D converter 8 is processed by digital signal processor 9. As explained in more detail below, DSP 9 detects specific voice commands, such as “I 18” and “GAME OVER”, by comparing the incoming voice data with prerecorded samples of voice data stored in the memory of DSP 9.

Voice commands recognized by DSP 9 are transferred from DSP 9 to CPU 10. Various techniques of interfacing DSP 9 and CPU 10 can be utilized. For example, DSP 9 and CPU 10 may share a dual-port memory and DSP 9 may write to such a memory decoded voice commands whereas CPU 10 may read these commands from the dual-port memory. DSP 9 may also send recognized voice commands to CPU 10 over a serial communication channel. In particular, DSP 9 may emulate for CPU 10 game-relevant data, such as data broadcast by bingo caller terminal 12 to a radio-controlled player unit 5 over a radio channel as indicated by the dashed depictions of bingo caller terminal's antenna 36, bingo player unit's antenna 25 and RF waive 37. DSP 9 may also emulate for CPU 10 game-relevant keyboard entries that are typically made by players playing stand-alone commercial bingo player units which are not controlled by radio. Moreover, voice recognition functions of DSP 9 may be implemented internally in CPU 10 provided CPU 10 has adequate computational resources.

Once a voice command is received and recognized by CPU 10, it is processed by CPU 10 in a manner similar to an equivalent command manually entered by a player through touchscreen 11 or received over a wired and/or wireless communication channel from a bingo caller terminal. Thereafter, the operation of bingo player unit 5 becomes conventional and, therefore, is well known to those skilled in the art. For example, if a voice command “I EIGHTEEN” arrives at CPU 10, after being processed by the string of elements 7-9, CPU 10 marks bingo number “EIGHTEEN” on all electronic bingo cards monitored by unit 5. Similarly, if a voice command “GAME OVER” arrives at CPU 10, the CPU 10 advances to the next game in the bingo session. In particular, if the current game is not “progressive”, CPU 10 retrieves a new set of cards and a new bingo pattern for the next game in the current bingo session. In a nutshell, a bingo caller makes conventional game announcements that are broadcast by the public address system 1 to bingo player unit 5, whereby the bingo player unit 5 receives and digitally processes the caller's voice commands to yield equivalent digital game-relevant commands that are subsequently executed by player unit 5 in a conventional manner.

The operation of the invented system is focused on applicable speech recognition techniques. All standard techniques of speech recognition invariably involve steps of first, applying a Fast Fourier Transform (“FFT”) to the incoming digitized voice signal to convert the time-domain signal into an equivalent frequency-domain representation and, second, to compare the resulting frequency-domain representation with a standard library of frequency-domain representations of voice commands as disclosed in U.S. Pat. Nos. 5,562,453 to Wen and 3,584,782 to Bergland. However, standard techniques of voice recognition may not be directly applicable to a bingo hall environment because of serious operational, power, memory and computational constrains imposed by the very nature of a portable bingo player unit and, more importantly, by bingo game rules.

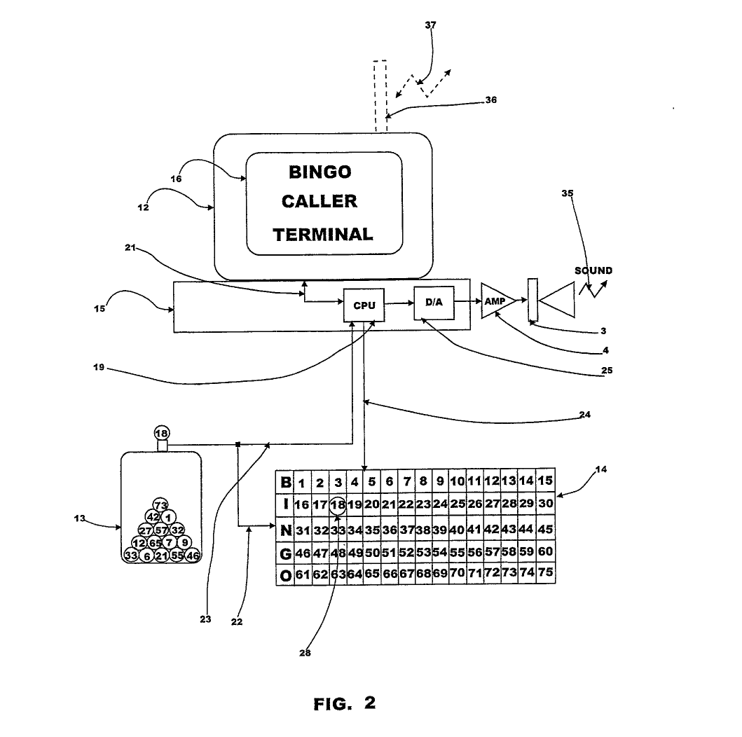

First, a portable bingo player unit 5 can not be activated by the voice of its actual user since players are not allowed to talk during bingo session. Only a bingo caller can conceivably command player units via the public address system 1. For example, bingo player unit 5 may be tuned to a standard prerecorded bingo caller's voice. Although different bingo callers may conduct bingo games in the same bingo hall, it may be acceptable in at least some bingo halls, to broadcast standard prerecorded game announcements, such as “I EIGHTEEN” and “GAME OVER”, via public address system 1 instead of broadcasting actual bingo caller's voice. Such a broadcasting of prerecorded voice commands must be synchronized with the actual game events. For example, a prerecorded voice announcement “I EIGHTEEN” must be broadcast via loudspeaker 3 when a bingo caller draws bingo ball “eighteen” from bingo ball hopper 13 and enters the drawn bingo number into computer 15 via touchscreen 16 as illustrated in FIG. 2. In the alternative, a bingo caller places the drawn ball in the bingo hopper 13, that having detected a newly inserted ball, sends a respective signal to flashboard 14 and/or CPU 19. In response to an activation of touchscreen 16, prerecorded voice data, “I EIGHTEEN” in this case, is sent by CPU 19 to Digital-to-Analog converter (“D/A converter”) 25 that converts digital voice data to an equivalent analog signal that is amplified by power amplifier 4 and communicated into loudspeaker 3. It is presumed that CPU 19 stores corresponding voice data in its memory and that CPU 19 is equipped with a sound card even though neither memory nor sound card are explicitly shown in FIG. 2. Note that concurrently with sending a prerecorded voice command to loudspeaker 3, CPU 19 also sends a conventional serial data packet to flashboard 14 to blink a corresponding number, in this case “I EIGHTEEN”, on Dashboard 14 as indicated by circle 28.

CPU 19 stores a set of sound files corresponding to the most frequently used caller voice announcements, such as “I EIGHTEEN” and “GAME OVER”. When a bingo caller enters a new called bingo number into bingo caller terminal 12 by touching a respective touch-button on touchscreen 16, CPU 19 retrieves a corresponding voice file, from its memory and outputs it to audio amplifier 4 via D/A 25. Similarly, when a bingo caller touches a “GAME OVER” touch-button on touchscreen 16, a sound file “GAME OVER” is played through amplifier 4 and a command to clear the flashboard is simultaneously sent by CPU 19 to Dashboard 14 via cable 24.

It is desirable to minimize a set of prerecorded voice commands to facilitate recognition of voice commands by an inexpensive bingo player unit 5 that has minimal computational resources. Since the overwhelming majority of all bingo caller announcements consists of bingo numbers, the standard set of voice commands may be reduced to seventy-five bingo numbers in the range of one to seventy-five plus one game-end command. Moreover, since all bingo numbers are two-digit numbers, the set may be reduced even further to phonemes identifying ten single digits plus phonemes identifying “tens-and-teens”.

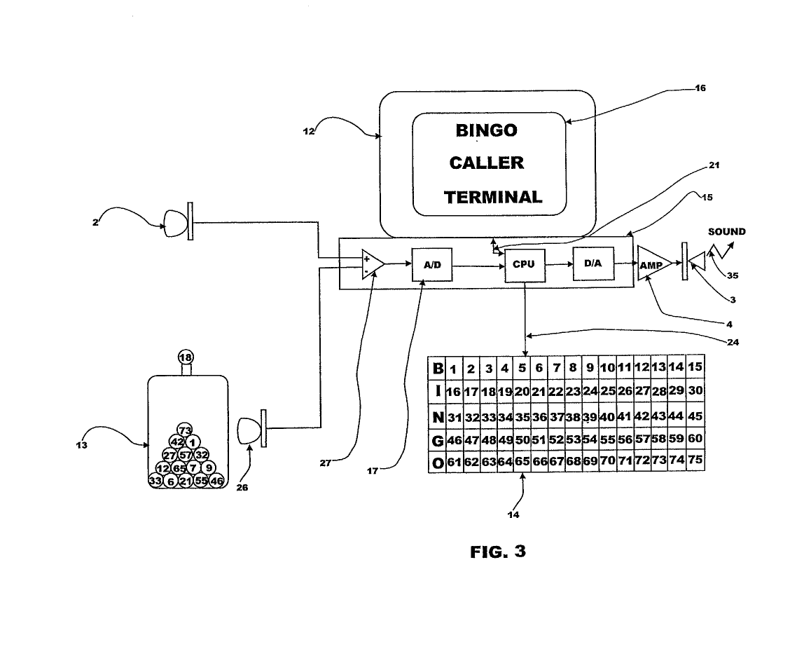

The above-described broadcasting of prerecorded voice commands may not be acceptable in all situations. If an actual caller's voice has to be utilized for public announcements, it is desirable to compress and filter it from noise, so that while being still clearly recognizable by players, it is convenient for machine recognition. FIG. 3 illustrates a modified bingo caller terminal 12 having provisions for filtering and reformatting a caller's voice. In addition to elements shown in FIG. 2, bingo caller terminal 12 of FIG. 3 is equipped with primary microphone 2 and a background microphone 26, an audio preamplifier 27 and an A/D converter 28. The primary microphone 2 is the same caller's microphone that is utilized in the standard public address system 1 of FIG. 1. The background microphone 26 is an additional microphone installed in close proximity to bingo ball hopper 13. Since ball hopper 13 is the main source of noise in a bingo hall, background microphone 26 provides a reference signal that may be utilized as an adequate approximation of the real-time noise level and of its primary frequency harmonics. Preamplifier 27 subtracts the noise reference signal generated by microphone 26 from the original signal generated by caller's microphone 2 and amplifies, and optionally filters, the resulting signals. As a result, the combination of microphones 2, 26 with preamplifier 27 performs a noise rejection function. The output signal of preamplifier 27 is digitized by A/D converter 17 and the output of A/D converter 17 is read-in by CPU 19. CPU 19 digitally processes a filtered caller's voice signal and detects specific voice commands identified in the stored set of voice commands. In particular, CPU 19 detects current game status announcements including called bingo numbers, patterns and game-over and session-over announcements. Having determined the current game status, CPU 19 causes said status to be displayed on the touchscreen display 16 and also on the bingo flashboard 14 as is illustrated in FIG. 1., wherein the last called number is highlighted on the flashboard 14 by a circle 28. Being capable of recognizing a caller's voice announcements, bingo caller terminal 12 effectively yields a voice-controlled “handsfree” bingo flashboard 14. This eliminates the possibility of manual error when a bingo caller announces one called number while flashboard 14 shows a different number because the bingo caller mistakenly placed a drawn bingo ball in a wrong location on the bingo hopper 13. Note that a bingo caller has the opportunity to override any voice command by direct entry of called bingo numbers into PC 15 via touchscreen 16. Also, a bingo caller has an option of turning off the voice recognition facility of bingo caller terminal 12 and instead, place drawn bingo balls into proper slots of bingo hopper 13.

Being a stationary PC-compatible device, bingo caller terminal 12 generally has computational and memory resources that by far exceed capabilities of hand-held and battery-operated bingo player unit 5. The plentiful computational resources of PC 15 can be utilized to further improve the system. In particular, PC 15 can execute advanced signal processing algorithms without a need for a separate DSP as illustrated in FIG. 3. In another embodiment, a DSP chip may be built-in into CPU 19. Also, CPU 19 can digitally filter typical noise frequencies generated by ball hopper 13 without any utilization of background microphone 26. Yet another advantage that vast computational resources of CPU 19 can yield is compressing the original voice signal, generated by caller's microphone 2, into a modified signal that while having substantially fewer harmonics than the original caller's voice, is still clearly recognizable by players. Having smaller bandwidth than the original voice, such a compressed signal is more conducive for recognition by bingo player unit 5 that has rather limited computational resources. Conventional techniques of digitizing voice and music are disclosed in “Sound Force 4.0 User Manual”, Sonic Foundry, Inc., 1996 and are quite beneficial for reducing the bandwidth of the compressed caller's voice.

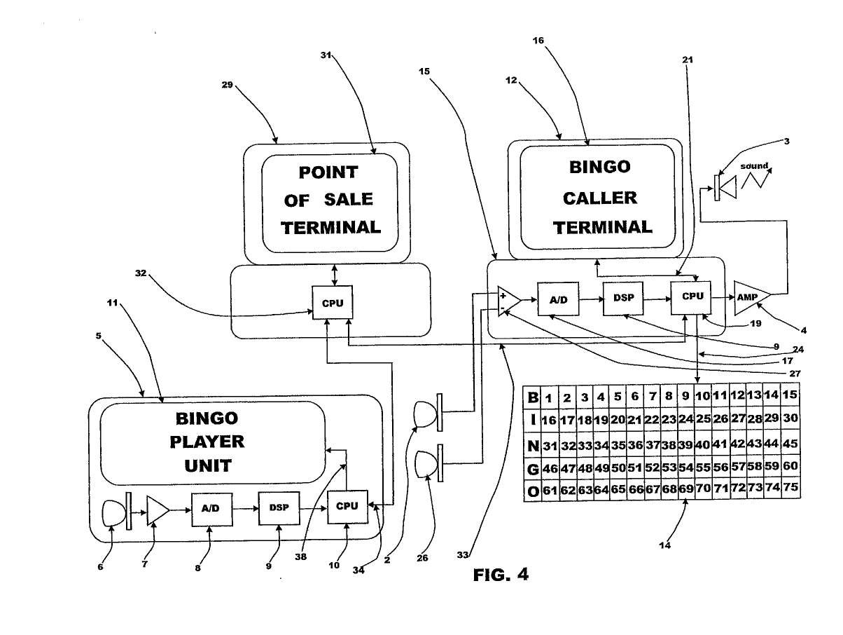

The issue of recognition of a caller's voice often is aggravated by the fact that several bingo callers may conduct bingo games in the same bingo hall. Frequently, several charitable organizations conduct bingo sessions in the same bingo hall on various days of the week or even during the same day and, therefore, bingo callers vary depending upon the time the session is conducted. Whereas an extensive set of voice commands including voice samples of many bingo callers may not present a problem for a powerful PC 15, bingo player unit 5 with limited memory resources may simply not be able to accommodate an extensive set of voice commands including voice samples of all bingo callers. The problem may be resolved by downloading a new set of voice commands into bingo player unit 5 for every bingo session conducted by a new bingo caller. In an overwhelming majority of applications, electronic bingo cards monitored by bingo player unit 5 are sold at a point of sale terminal 29 (“POS”), such as POS 29 shown in FIG. 4. Similar to bingo caller terminal 12, POS 29 is a PC-compatible computer 30 equipped with a touchscreen monitor 31 controlled by a CPU 32. In many bingo halls, PC 29 is networked with bingo caller terminal 12 via a local area network (LAN) cable 33, and sometimes, especially in small bingo halls, a multi-tasking bingo caller terminal 12 carries functions of POS 29 as well. In a typical installation, POS 29 downloads in bingo player unit 5 the bingo card purchased by the unit's user and also downloads a schedule of games to be played in the bingo hall. The downloading of cards and schedules is performed via a downloading cable 34 shown in FIG. 4 or may also be carried through an infrared channel emulating functions of cable 34. It is possible and desirable to download to bingo player unit 5, from POS 29 via the same downloading interface 34, a unique set of voice commands characteristic of a specific bingo caller who conducts a bingo session for which the bingo cards are sold.

Although the above description is focused on the subject of voice command activation of bingo player unit 5, the bingo unit 5 may also be at least partially operated in a conventional manner through touchscreen 11 and/or radio channel 37. Depending on jurisdictional requirements and bingo hall management preferences, some game-relevant commands may be input into bingo player unit over radio channel 37 while others may be input via an acoustic channel 35 and/or touchscreen 11.

The described above techniques of playing bingo with the help of a voice-activated electronic device are applicable to games other than bingo as well. In particular, the game of keno can be played with the help of an electronic device activated by keno caller's voice in a manner similar to game of bingo.

Although the invention has been described in detail with reference to a preferred embodiment, additional variations and modifications exist within the scope and spirit of the invention as described and defined in the following claims.

We claim:

1. An electronic voice activated gaming device for tracking a status of a wagering game including;
means to receive a voice command broadcast over a public address system; and
means to input and record said received voice commands.

2. Gaming device of claim 1 wherein said gaming device tracks the status of a bingo game.

3. Gaming device of claim 2 wherein said gaming device tracks said status of at least one bingo card.

4. Gaming device of claim 2 wherein said gaming device is for use by a bingo player.

5. Gaming device of claim 1 wherein said voice command includes at least a called bingo number.

6. Gaming device of claim 1 wherein said voice command includes at least a bingo pattern identification.

7. Gaming device of claim 1 wherein said voice command includes at least a game identification.

8. Gaming device of claim 1 wherein said voice command includes at least a game start.

9. Gaming device of claim 1 wherein said voice command includes at least a game end.

10. Gaming device of claim 1 wherein said gaming device is a portable battery-operated device.

11. Gaming device of claim 1 wherein said voice command is a pre-recorded voice announcement.

12. Gaming device of claim 1 wherein said voice command is filtered by a noise-rejection means.

13. Gaming device of claim 12 wherein said noise rejection means includes a microphone located proximate to a bingo ball hopper.

14. Gaming device of claim 1 wherein said voice command is filtered to reduce a bandwidth of said voice command.

15. Gaming device of claim 4 wherein said gaming device includes a set of sample bingo voice commands to be broadcast over said public address system.

16. Gaming device of claim 15 wherein said sample set of bingo voice commands is at least partially optimized for a specific bingo caller's voice.

17. Gaming device of claim 2 wherein said electronic bingo device is for use by a bingo caller.

18. Gaming device of claim 1 wherein said public address system broadcasts a pre-recorded voice announcement responsive to a voice command, said voice command being equivalent semantically to said prerecorded voice announcement.

19. Gaming device of claim 18 wherein said pre-recorded voice announcement is related to a game of bingo.

20. Gaming device of claim 17 wherein said gaming device digitally processes an input voice command by filtering noise and compressing bandwidth and thereafter said gaming device broadcasts a result of said digital processing over a public address system.
